(19) United States
(12) Patent Application Publication
(10) Pub. No.: US 2025/0348784 A1
(43) Pub. Date: Nov. 13, 2025

(54) APPLICATION OF AI/ML TO CLUSTERS

(71) Applicant: HEWLETT PACKARD ENTERPRISE DEVELOPMENT LP, Spring, TX (US)

(72) Inventors: Biswadeb Dutta, Chestnut Hill, MA (US); Perrine Barale, Mougins Alpes-Maritimes (FR); Raul De Diego Merino, Madrid (ES)

(21) Appl. No.: 18/819,083

(22) Filed: Aug. 29, 2024

(30) Foreign Application Priority Data
May 7, 2024 (EP) 24305716.3

(51) Int. Cl. G06N 20/00; G06F 18/2321

(52) U.S. Cl. CPC G06N 20/00; G06F 18/2321

(57) ABSTRACT

Systems and methods are provided for simplifying the generation/application of machine learning models in a network or other deployment of elements or objects of interest. Data (which can be multi-variate, high dimensional, time-series) regarding or associated with such objects may be represented as random matrices, which can then be transformed diagonal variance matrices. Upper and lower confidence bounds can be determined with which to test similarity between the now, diagonal matrices. Based on the determined similarity or dissimilarity, one or more clusters of matrices, representative of the objects of interest, can be determined. In this way, machine learning models can be trained and developed to be operationalized for the clustered matrices (objects) rather than individual matrices (objects).

### BACKGROUND

In non-virtualized networks, network functions (NFs) are implemented as a combination of vendor-specific software and hardware, which can be referred to as network nodes or network elements. Such NFs can be connected or chained in a certain manner to achieve a desired overall functionality or service. Reliance on the virtualization and containerization of NFs has dramatically increased the complexity involved with managing communication networks.

### BRIEF DESCRIPTION OF THE DRAWINGS

The present disclosure, in accordance with one or more various embodiments, is described in detail with reference to the following figures. The figures are provided for the purposes of illustration only and merely depict typical or example embodiments.

FIG. 1 is a schematic representation/flow chart illustrating operations/functionality of some examples of the disclosed technology.

FIG. 2 is an example computing component that may be used to implement raw data pre-processing in accordance with some examples of the disclosed technology.

FIG. 3 is an example computing component that may be used to implement pair-wise similarity determinations in accordance with some examples of the disclosed technology.

FIG. 4 is an example computing component that may be used to implement clustering in accordance with some examples of the disclosed technology.

FIG. 5 is an example computing component that may be used to implement machine learning (ML) model generation and operationalization in accordance with some examples of the disclosed technology.

FIG. 6 is an example computing component that may be used to implement simplified artificial intelligence (AI)/ML application in accordance with some examples of the disclosed technology.

FIG. 7 is an example computing component that may be used to implement various features of examples of the disclosed technology.

The figures are not exhaustive and do not limit the present disclosure to the precise form disclosed.

### DETAILED DESCRIPTION

Examples of the disclosed technology seek to improve upon the conventional application of artificial intelligence (AI)/machine learning (ML) to or within a system or network. In particular, systems or networks may exist, where nodes, elements, or components of such systems or networks generate or process various types of data. As will be described in greater detail below, one example of such a system or network is a digital service provider (DSP) network comprising a variety of elements or components used to effectuate communication. In such scenarios, the number/variety of ML models/algorithms generated for predicting or otherwise processing the disparate types of data is typically commensurate with the number of disparate types of data. Indeed, ML models' accuracy tends to depend on training/processing the same (or at least a similar) type(s) of data. Even in situations where the type(s) of data are similar, the values/characteristics of that data may be different enough that using, e.g., a single ML model, to represent or make predictions across the varied dataset, would likely not be accurate.

In the above-described scenarios, data tends to be multivariate and highly dimensional. Multivariate data can refer to data, that at any one sample point, contains multiple, scalar values that represent different simulated or measured quantities. This is in contrast to univariate data or statistics, where only a single variable is represented or summarized by the data. For example, and as will be discussed in greater below, in a DSP context, the radio access network (RAN) may comprise user equipment (UE), base stations, such as eNodeBs, and the distributed unit (DU), which performs, e.g., user plane functions such as data processing and transmission. A desired function regarding the RAN may be automated health monitoring/anomalous operation detection. For example, the eNodeBs of a RAN may monitor their own operation and generate data regarding their health. That health data can include a plurality of variables or features that, in this example, characterize the overall health of an eNodeB (weather variables, operating environment variables, internal operating component variables, and so on). Highly-dimensional data can refer to datasets with large numbers of variables or features relative to the number of observations made regarding those variables or features. Following the above example, health data samples may be taken every 24 hours or every week/bi-week/month/etc., where again, the data can comprise multiple variables or features. For example, data is typically received asynchronously from a network in 15-minute intervals, although some DSPs configure their networks to generate data more frequently, e.g., on the order of about every 5 minutes. Business needs may drive frequency.

Creating and operationalizing (or putting in production) large numbers of ML models can be cost-prohibitive, and can introduce an undesirable increase in the complexity of a system or network, among other disadvantages. To address such scenarios, examples of the disclosed technology create matrix representations of data that can be simplified and reduced in complexity. That is, matrices can represent raw (multivariate/high-dimensionality) data. The matrices can be reduced to diagonal matrices comprising variance values (eigenvalues). These variances or eigenvalues can be used as a basis for determining node/element similarity relative to the data generated by a node/element by way of creating a vector of the eigenvalues. Depending on whether or not nodes/elements are similar (or how similar nodes/elements may be) in terms of the data generated regarding such nodes/elements, examples of the present disclosure may cluster the matrices representative of the data/nodes in a system or network. Thereafter, appropriate ML algorithms (and eventually, models) can be developed for determined clusters, rather than individual nodes/elements, data types, etc. In this way, the application of AI/ML to a system or network can be simplified (or optimized) by generating and operationalizing ML models that are applicable to multiple nodes/elements/data as opposed to singular nodes/elements/data. Ultimately, the number of ML models that are generated and operationalized in accordance with various examples of the present disclosure are reduced when compared to conventional application of AI/ML in similar scenarios, while still retaining a requisite/desired level of accuracy.

In particular, and for example, current generation DSPs, e.g., AT&T, Verizon, etc. have leveraged technologies such as virtualization, containerization, and cloud computing to improve service, service more customers, etc. However, the result is that DSP RAN componentry, e.g., eNodeBs and gNodeBs, has grown exponentially. For example, AT&T and Verizon have on the order of 300,000 RAN elements. DSPs in Asia/India have RANs with up to 450,000 elements. Accordingly, the amount of data/data processing in the context of network monitoring/maintenance has exploded, especially for edge computing.

Not only is the data generated by such nodes characterized as high dimensionality, multivariate, time-series data, making processing such data difficult, but such data is typically, only weakly correlated. Thus, the dimensionality of the data cannot be dropped/ignored. Furthermore, the data generated at such nodes is raw, unlabeled data. Hence, before machine learning can be applied to, e.g., predict anomalous behavior at a node(s), data should first be labeled/categorized. Further still, given the spatial diversity and scale discussed above, generating/developing ML algorithms/analytical methods for each RAN element, e.g., each eNodeB of a network, is unfeasible.

Accordingly, examples of the disclosed technology are directed to reducing the number of supervised ML models operationalized for a network by clustering or grouping, in one example context, RAN elements, based on similarity of the RAN elements, more particularly, data-based behavior of the RAN elements. Again, in this way, smaller numbers of supervised ML models can be used to predict anomalous behavior across the network of nodes/RAN elements. In some examples, the data at issue is a random matrix (in mathematical terms) of, e.g., measurements regarding the health of a RAN element over time. Grouping or clustering nodes based on random vectors representing the multivariate data (at each instance of time) will not work. That is, each measurement or dimension is a time series, and the behavior or characteristics of a time series cannot be captured merely by considering a value of the measurement or dimension at a single time/timestamp. A vector representing the multivariate data would not be able to represent the “complete” behavior of the multi-variate time series. Instead, the problem of matrix similarity (or Approximate Nearest Neighbors) is addressed as follows. A principal component analysis (PCA) algorithm may be used to derive an eigenvalue (variance) matrix from the random matrix, where the similarity of eigenvalues between nodes or RAN elements is the basis for clustering nodes/RAN elements. It should be noted that in accordance with disclosed examples, PCA is used for feature engineering, rather than dimensionality reduction (as it may be used conventionally). It should also be noted that the dimension of the eigenvalue matrix is the same as the number of time series, i.e., the same as the dimensionality of the multi-variate data. As noted, the data at issue may be weakly correlated, meaning that the highly-dimensional nature of the data cannot be ignored. Thus, the dimensionality of the data is not ignored or dropped in accordance with examples of the disclosed technology-rather, certain mathematical techniques may be used to modify the matrix representation of the multi-variate data. The characteristics of the actual multi-variate data are still preserved.

In some examples, statistical hypothesis test methods, such as the Chi-Square test and the F-test (both of which can be used for testing two elements) can be extended and applied to multi-variate time series data to determine upper and lower confidence bounds for testing node/RAN element similarity. An n-dimensional vector is created with the eigenvalues from the random matrix associated with each node/RAN element, where the vectors of the eigenvalues are clustered using, e.g., an Agglomerative Clustering algorithm. Once a cluster(s) is determined or created, appropriate ML models/algorithms can be built. Because the ML models/algorithms have been created on a per-cluster basis, the number of ML models/algorithms that are to be developed and ultimately, put into production, will be less than would have been developed and operationalized otherwise.

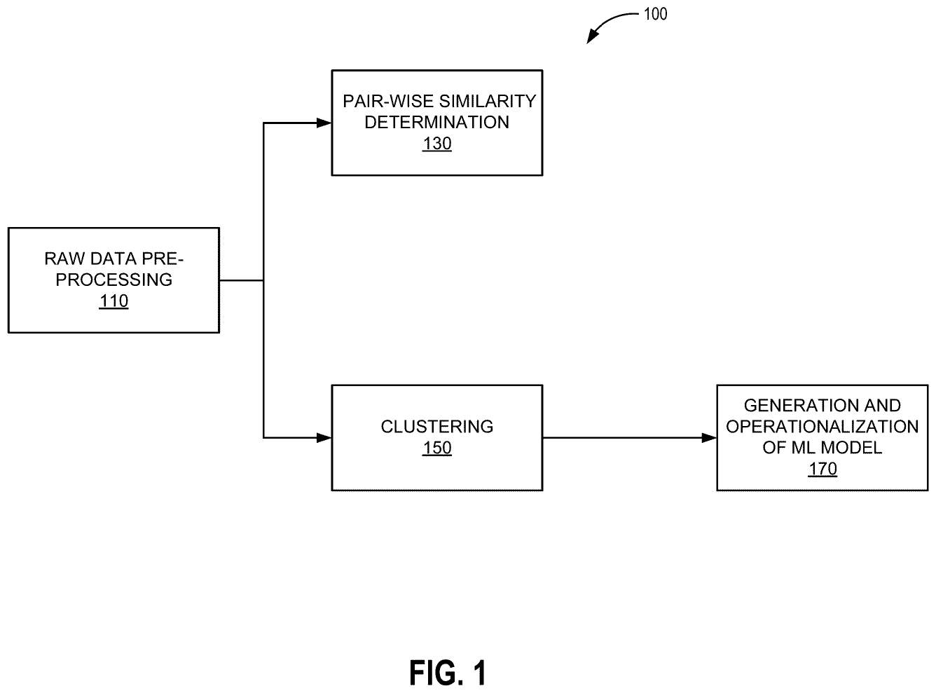

FIG. 1 is a flow chart illustrating example operations or functionalities comprising a method 100 that may be performed to effectuate simplified ML model usage. The method 100 may be performed in a server/cluster of servers at a centralized location, e.g., in the context of DSPs, at a DSP datacenter. At operation 110, pre-processing of raw data may be performed. Pre-processing raw data may comprise representing the raw data as/in random matrices, and transforming (by reducing) such random matrices to diagonal matrices. The diagonal matrices comprise variance values or eigenvalues, which can represent the total amount of variance that can be explained by a given principal component.

The raw data may be data generated by or received from nodes of a system or network. Following the above examples, the raw data may be high-dimension, multivariate, time-series data. For example, in the RAN context, such data may have over 3000 dimensions per node that, e.g., characterize attributes of RAN radio node (eNodeB), e.g., control-plane attributes (bearer, handover, paging, resource-control), and user-plane attributes (throughput, volume, quality of service (QOS)). Indeed, network data tends to exhibit specific trends, cyclical behavior, and seasonalities. As noted, a RAN may have large numbers of elements, e.g., on the order of 50,000 to 400,000 radio nodes/eNodeBs in a given network leading to data that has/reflects a high spatial density.

DSPs typically process vast amounts of data to achieve desired visibility into the status and health of their networks. The raw data in this example is unlabeled data. Accordingly, such data should be labeled/annotated/categorized if supervised ML models are to be used to predict, in this example, anomalous (or similar and dissimilar) behavior of eNodeBs in real time. In other words, an unsupervised learning problem is to be mapped to a supervised learning problem. Because the data generated by each of the NFs/eNodeBs could exhibit or reflect very different behavior, typically, a large number of supervised ML models would have to be built to address the vast amount of data. Additionally, beyond dealing with data that is weakly correlated, highly dimensional, multivariate time-series data, further complexities may arise with respect to spatial diversity and scale.

At operation 130, a pair-wise similarity (between two nodes) determination is performed. In some examples, determining the similarity between two nodes (represented by respective random/diagonal matrices) can be achieved by first, determining confidence intervals about or relative to the variance or eigenvalues. These confidence intervals apply to univariate time-series (after the reduction of the random matrices), but using Chi-square distribution, can be extended back to multivariate time-series data (for a pair of univariate time-series datasets). In this way, the determined confidence intervals can be used to test or judge whether or not the pair of random matrices are similar or dissimilar.

A ratio of traces may be used to compare the similarity of a pair of objects, e.g., nodes, but it is not computationally efficient to perform similarity comparisons between each node in a network, especially when, as discussed above, the number of nodes can be very large, and the data to be compared is represented by random matrices. Thus, ratio of traces comparisons can be used selectively to compare the behavior of a single object/node at different time intervals or to compare the behavior of a pair of nodes/objects within the same time interval. That is, as discussed above, a random matrix can be used to represent the data associated with each node. As also discussed above, such random matrices may be reduced to diagonal matrices by way of applying the aforementioned PCA (or singular value decomposition (SVD)) techniques discussed in greater detail below. A trace of a matrix can refer to the sum of the elements on the main diagonal of a matrix. In accordance with examples of the present disclosure, a trace is the sum of elements of a diagonal matrix derived from a random matrix representative of the data associated with a node or element. It is such traces that may be compared (creating a ratio of traces) to determine data similarity, and by virtue of the data, node/element similarity or dissimilarity. Comparisons between nodes or objects may be iteratively performed to determine the similarity/dissimilarity between the additional nodes/objects at issue. Because the comparisons only involve traces, the volume or number of comparisons to be made becomes a practically, feasible task.

At operation 150, clustering of random matrices representative of node behavior is performed. That is, in response to determining whether or not various nodes/random matrices are similar, a collection of random matrices describing the behavior of a collection of NFs or nodes/elements remains. To cluster or group similar random matrices, an n-dimensional vector may be created comprising retrieved eigenvalues from the diagonal singular value matrix for each node/element, from which traces can be derived. As described above, those traces can be compared and based on their “distance” from one another (evidencing similarity or dissimilarity, clusters can be determined). Various clustering techniques may be leveraged. In some examples, a K-means algorithm may be used to cluster eigenvalue vectors. In some examples, an agglomerative clustering algorithm may be utilized. The result, as already discussed, is the creation of clusters, which in turn, allows for ML models or algorithms to be created on per-cluster basis, rather than a per-node/element basis.

At operation 170, one or more ML models (corresponding to clusters) are generated and operationalized. In some embodiments, the multivariate data associated with each node/element can be divided into training, validation, and testing datasets. From those per-node/element datasets, samples are obtained which are representative of the cluster to which those nodes/elements belong. A desired or appropriate ML algorithm can be trained with the sampled cluster training dataset, from which an ML model may be derived. Once trained, the ML model can be put into production or operationalized onto the system or network, and can process/predict/draw inferences on the collected data. Following the above examples, an appropriate ML model may be, e.g., an eNodeB predictive maintenance ML model used to predict anomalous behavior of eNodeBs that may suggest health/operational issues that warrant some remediation or fix/mitigating action. The predictive behavior of the generated ML model may be validated using the validation datasets. Like the training datasets, samples may be obtained from each of the nodes/elements making up a determined cluster for validating the ML model. That is, the random matrices representative of the data can, themselves, be used to assemble the training, validation, and testing datasets. In accordance with some examples of the disclosed technology, during production, the ML Model can be tested (with cluster-representative testing data) to evaluate the predictive behavior of the ML model. For example, if the ratio of traces of the variances/eigenvalues is no longer in the neighborhood of unity, re-training of the ML model may be warranted, in which case, the ML model can undergo training again with multivariate testing data from the nodes/elements making up the cluster to which the ML model has been applied.

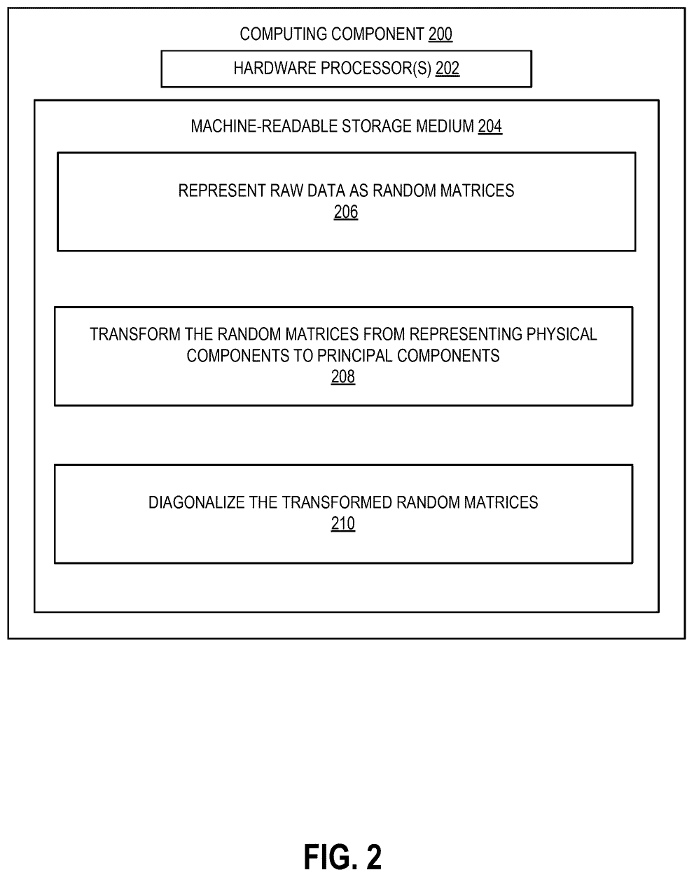

FIG. 2 is an example computing component 200 that may be used to implement various features of the elements, network functions, etc. illustrated in FIG. 1, in this example, to effectuate operation 110 in accordance with one example of the disclosed technology to pre-process raw data. Computing component 200 may be, for example, a server computer, a controller, or any other similar computing component capable of processing data. In the example implementation of FIG. 2, the computing component 200 includes a hardware processor 202, and machine-readable storage medium 204 may embody a server/server cluster implemented at a datacenter, network management center, or similar location or entity.

Hardware processor 202 may be one or more central processing units (CPUs), semiconductor-based microprocessors, and/or other hardware devices suitable for retrieval and execution of instructions stored in machine-readable storage medium 204. Hardware processor 202 may fetch, decode, and execute instructions, such as instructions 206-212, to perform raw data pre-processing as part of optimizing/simplifying ML model use in a system. As an alternative or in addition to retrieving and executing instructions, hardware processor 202 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 204, may be any electronic, magnetic, optical, or other physical storage device that contains or stores executable instructions. Thus, machine-readable storage medium 204 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 604 may be a non-transitory storage medium, where the term “non-transitory” does not encompass transitory propagating signals. As described in detail below, machine-readable storage medium 204 may be encoded with executable instructions, for example, instructions 206-212.

Hardware processor 202 may execute instruction 206 to represent raw data as random matrices. A set of high-dimensionality, multivariate time-series data may be referred to/organized into a random matrix. Such a random matrix may reflect time-series data associated with multiple nodes. To determine whether or not a particular node is exhibiting behavior that is similar or dissimilar to another node(s), or that amounts to anomalous behavior, the data from one time period/sample can be compared to data from another, e.g., earlier, time period/sample. As explained herein, simple, typical clustering approaches or methodologies are inapplicable to random matrices that represent multivariate data, e.g., at various instances in time.

In accordance with one example, SVD and PCA techniques may be leveraged to find a mathematical representation of a random matrix, to which standard statistical and unsupervised ML techniques may be applied. In some examples, hardware processor 202 executes instruction 208 to transform the random matrices from representing physical components to principal components. The transformation can be based on mathematical calculations based on linear algebra applying the SVD result/theorem. That is, the SVD and PCA techniques can be used to derive a diagonal, single vector matrix from a random matrix. Accordingly, hardware processor 202 may execute instruction 210 to diagonalize the transformed random matrices. This diagonal matrix can comprise the variances or eigenvalues of the principal components. It should be noted that, PCA, for example, can be used to transform a number of potentially related/correlated variables into a smaller number of variables referred to as principal components. In other words, PCA can be used to extract features from the data by combining input variables in a way, mathematically, that allows the least important variables to be dropped or ignored, while the most/more important variables are retained.

However, it should be noted that in contrast to typical applications of SVD and PCA techniques, which work with principal components of the data, and thus enable the dimensionality of a problem to be reduced (e.g., audio de-noising), examples of the present disclosure leverage the eigenvalues to determine node similarity/dissimilarity and whether or not similarly-behaving nodes can be clustered together. In other words, the use of SVD/PCA in accordance with various examples is for feature engineering purposes. Recall that examples of the present disclosure seek to first, determine a mathematical representation of random matrices characterizing node behavior, where the random matrices comprise high-dimensional, multivariate, time-series data. The SVD/PCA techniques, in accordance with examples of the present disclosure, can be used to transform the random matrices from representing physical components in the vector space (e.g., eNodeBs) to a vector space of principal components. In this way, a random matrix, characterized by symmetric, positive definite, variance-covariance data in an original vector space can be diagonalized in the physical component vector space. Accordingly, and as will be discussed in greater detail, statistical and unsupervised machine learning techniques can be leveraged (i.e., similarity can be determined based on the eigenvalues of the diagonal matrix).

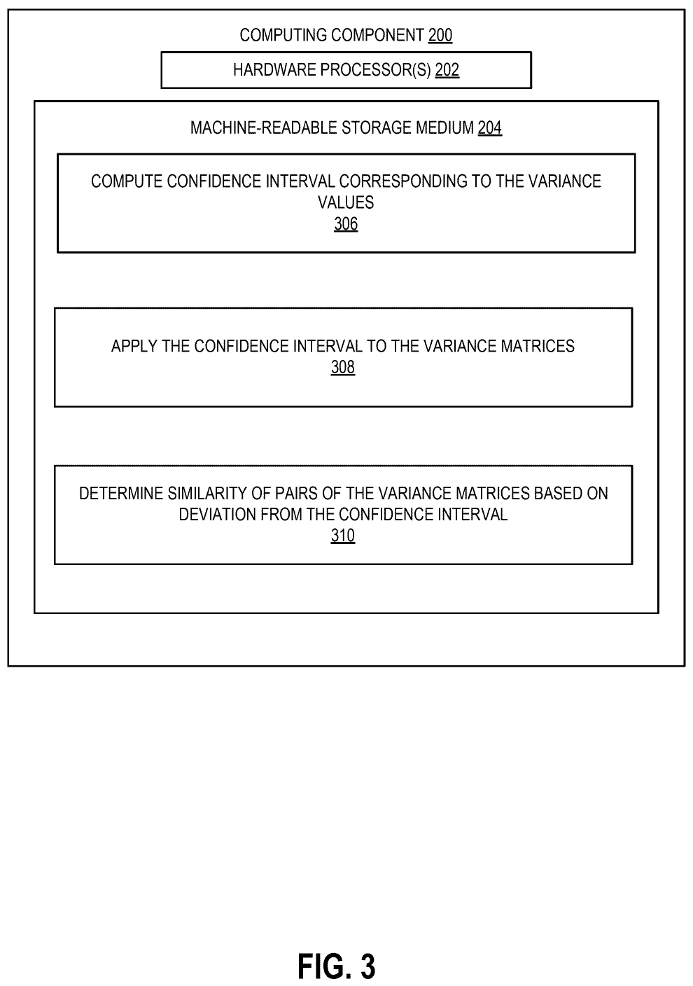

FIG. 3 illustrates example computing component 200 that may also be used to implement various features of the elements, network functions, etc. illustrated in FIG. 1, in this example, to effectuate operation 130 in accordance with one example of the disclosed technology to determine the similarity of nodes represented by the data that they may produce. Computing component 200, as already described, may comprise a hardware processor 202, and machine-readable storage medium 204. Following the above example, multiple nodes such as eNodeBs generate various health data or data that can characterize the operation of such eNodeBs, e.g., observability data. Thus, examples of the present application seek to analyze the data generated by these nodes (indicative of their performance/operation) in order to determine whether or not they are behaving or operating similarly to another one or more nodes. Nodes that, by virtue of the data they generate, appear to operate similarly, or are in a similar condition/state of operation, can be grouped for purposes of developing ML algorithms/models.

Hardware processor 202 may execute instruction 306 to compute a confidence interval corresponding to the variance values. As discussed above, raw data can be represented as a random matrix, and simplified (reduced) to a diagonal matrix with the variance (eigenvalues) reflected in the diagonal direction, while the covariance of parameters are reflected outside of the diagonal.

Hardware processor 202 may execute instruction 308 to apply the confidence interval to the variance matrices. That is, the standard result for the confidence intervals of the variance can be extended to that for multi-variate time series. This is possible given the sample variance of a uni-variate time series using Chi-square distribution. That is, and with respect to the following equations, “a” and “b” may refer to the lower and upper bounds of the Chi-square distribution for a normally-distributed random variable. The “σ” refers to the variance of a random variable under consideration, while the “s” can refer to the standard deviation of the random variable. The “n” may refer to the number of realizations of the random variable in a sample, and the “n−1” can refer to the number of degrees of freedom.

Hardware processor 202 may execute instruction 310 to determine the similarity of pairs of the variance matrices based on deviation from the confidence interval, where F-distribution techniques may then be used to analyze the variances as follows. The F-distribution of a random variable being considered may be defined as the ratio of a pair of independent random variables. Here, the independent random variables will be the variances of two time series. For example, “m” and “n” may represent the number of degrees of freedom of each independent random variable. Extending the formulation for the confidence intervals from a single random variable to multiple random variables results in a trace as described above. The “α” may be a number between 0 and 1, and can be used to express a percentile of the F-distribution that is designated to correspond to a percentage of the confidence.

$$\frac{\sqrt{n - 1}}{\sqrt{b}} s \leq σ \leq \frac{\sqrt{n - 1}}{\sqrt{a}} s {⟹}_{\begin{matrix}apply to the trace \\ of eigenvalues\end{matrix}} \frac{\sqrt{n - 1}}{\sqrt{b}} T r ( s ) \leq T r ( σ ) \leq \frac{\sqrt{n - 1}}{\sqrt{a}} T r ( s )$$

$${F}_{1 - \frac{α}{2}} ( m - 1 , n - 1 ) \frac{{S}_{X}^{2}}{{S}_{Y}^{2}} \leq \frac{{σ}_{X}^{2}}{{σ}_{Y}^{2}} \leq {F}_{\frac{α}{2}} ( m - 1 , n - 1 ) \frac{{S}_{X}^{2}}{{S}_{Y}^{2}} s {⟹}_{\begin{matrix}apply to the trace \\ of eigenvalues\end{matrix}} {F}_{1 - \frac{α}{2}} ( m - 1 , n - 1 ) \frac{T r ( {S}_{X}^{2} )}{T r ( {S}_{Y}^{2} )} \leq \frac{T r ( {σ}_{X}^{2} )}{T r ( {σ}_{Y}^{2} )} \leq {F}_{\frac{α}{2}} ( m - 1 , n - 1 ) \frac{T r ( {S}_{X}^{2} )}{T r ( {S}_{Y}^{2} )}$$

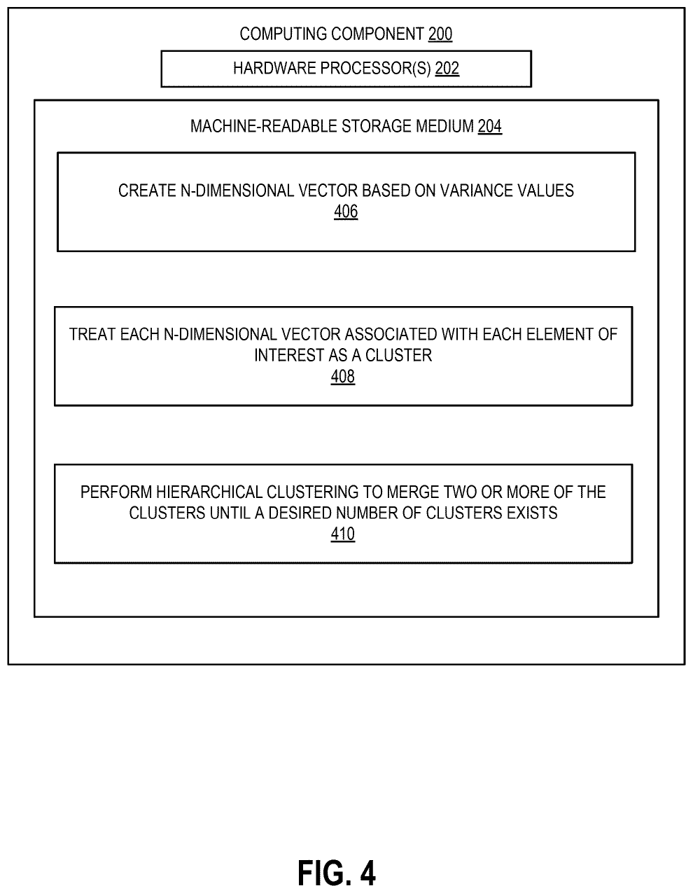

FIG. 4 illustrates example computing component 200 that may also be used to implement various features of the elements, network functions, etc. illustrated in FIG. 1, in this example, to effectuate operation 150 in accordance with one example of the disclosed technology to cluster nodes represented by the data that they may produce. Computing component 200, as already described, may comprise a hardware processor 202, and machine-readable storage medium 204.

Hardware processor 202 may execute instruction 406 to create an n-dimensional vector based on variance values. As discussed, during pre-processing, a diagonal vector of variance values or eigenvalues is derived from the random matrices representative of the raw data collected from nodes. Creating this n-dimensional vector may comprise retrieving the eigenvalues from the diagonal (single value) matrix generated for each node. In some examples, the vector may be an n-dimensional vector comprising three dimensions: the confidence interval upper bound; the confidence interval lower bound, and the trace of the singular value matrix (or sum of the eigenvalues). Alternatively, the n-dimensional vector may comprise a k-dimensional vector of the normalized eigenvalues/variances. The “k” of the k-dimensional vector can refer to the number of principal component dimensions needed to achieve a target total explained variance. In this context, the explained variance refers to a measure of how much of the data's variance is accounted for by a mathematical model. Often, in practical applications, it is found that by considering a fraction of the total variance one is able to determine with an adequate representation or explanation of a system's behavior. This is the explained variance that can be used. Generally, the goal is to reduce computational complexity, and at the same time retain a sufficiently good explanation for the observed behavior.

The use of an n-dimensional vector such as the n (in this case 3) or k-dimensional vector can lead to faster clustering of the random matrices representative of the nodes, and with more precision than if an entire dataset were used. Attempts to cluster univariate time series data (corresponding to individual nodes) separately, and apply some ensembling mechanism to combine the predictions of multiple models together (resulting from the running of each of the multiple models on separate inputs) is costly, both from resource-usage and latency perspectives. For example, the (compute) cost of processing resources, such as hardware processor 202, can be reduced because clustering in accordance with various examples, based on the eigenvalues, need not process data with a large number of dimensions. Again, the totality of the behavior exhibited by nodes (in particular the random matrices associated with each node) can be represented by vectors having n (3) dimensions or k dimensions.

Hardware processor 202 may execute instruction 408 to treat each n-dimensional vector associated with each element of interest as a cluster. In some examples, once the eigenvalue vector has been created (and represents each node or element of interest) as discussed above, a hierarchical clustering method can be applied. That is, hardware processor may execute instruction 410 to perform hierarchical clustering to merge two or more of the clusters until a desired number of clusters exist. Hierarchical clustering, one type of which is referred to as agglomerative clustering, refers to a cluster analysis method that seeks to build a hierarchy of clusters, where each object or element of interest is treated as a singular cluster. Then, pairs of clusters are merged until a desired number of clusters is reached.

Typically, some measure of dissimilarity (or lack of likeness) may be the basis on which clustering is performed. In some examples, a distance, d (representative of the distance or disparity between, in this example, eigenvalue vectors representative of the random matrices of nodes) is defined. In some examples, the L2 norm (also referred to as the Euclidean norm) can be used. This L2 norm is a measure of the shortest distance of a vector from an origin (i.e., the origin of a cartesian coordinate system in which the vector of eigenvalues exists, and may be defined as the root of the sum of the squares of the components of the vector. The desired number of clusters can be set by specifying the cut-line/depth of the agglomeration. That is, agglomeration clustering can be performed until a plurality of clusters are merged (hierarchically) pair-by-pair until a single, inclusive cluster is achieved. Setting the depth (recalling that agglomerative clustering is a type of hierarchical clustering based on distance) equates to setting a limit as to how far the agglomeration clustering proceeds. As discussed herein, reducing the number of ML models needed to service a system, in some examples, the RAN of a communications network, results in smaller numbers of ML models being generated, while still retaining a desired level of accuracy. A user/administrator/other entity can determine a desired balance between size of clusters/how many clusters will result and desired level of accuracy of the per-cluster ML models.

ML models can lose accuracy over time, e.g., due to changing data trends. The accuracy of predictions made by a per-cluster ML model can decrease, in which case, examples of the disclosed technologies may commence with re-training of the per-cluster ML model. A loss of accuracy can be determined when a ratio of the traces of variances (a ratio of eigenvalue vector traces, discussed above) is no longer in the neighborhood of unity. That is, the ratio of traces can produce a value. A value of one or near one, for example, means that the respective values of the traces being compared are the same or close to being the same. A lack of unity means that the trace values are not the same/similar. Here, unity can be defined as being within the lower/upper confidence bounds.

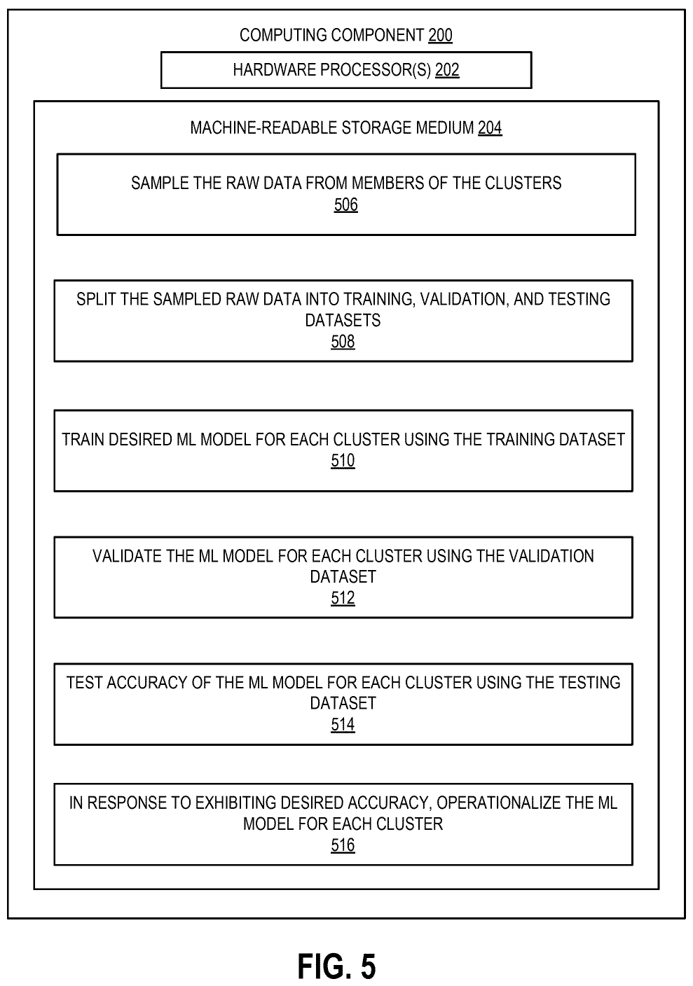

FIG. 5 illustrates example computing component 200 that may also be used to implement various features of the elements, network functions, etc. illustrated in FIG. 1, in this example, to effectuate operation 170 in accordance with one example of the disclosed technology to generate and operationalize an ML model. Computing component 200, as already described, may comprise a hardware processor 202, and machine-readable storage medium 204.

Hardware processor 202 may execute instruction 506 to sample raw data from members of the clusters. The raw data, as discussed herein, may be multivariate, high-dimensionality data generated by nodes or elements, e.g., eNodeBs (4G) or gNodeBs (5G) of a communications network. Following the above-discussed example scenario, such nodes may generate data regarding the operation or behavior of the nodes, which can be indicative of the health of the nodes. As also discussed above, the nodes of a network can be clustered based on the similarity of the data generated by those nodes, and an appropriate ML model can be derived for clusters (rather than individual nodes). Once an appropriate ML model is chosen/derived for a cluster(s), the ML model, as expected, undergoes training.

Accordingly, hardware processor 202 may execute instruction 508 to split the sampled raw data into training, validation, and testing datasets. Typically, more “resources” are spent on training versus validation and testing. Accordingly, in some examples of the disclosed technology, the split may emphasize the training dataset more than the validation or testing datasets. For example, 70% of the sampled raw data may go to training, i.e., used to derive the training dataset for training a selected ML algorithm that will ultimately result (post-training) in the desired ML model for that cluster. The remaining 30% of the sampled raw data may be further split or categorized into a validation dataset and a testing dataset, e.g., 15% of the sampled raw data may be used in a validation dataset, and 15% of the sampled raw data may be used in a testing dataset. However, the ratio of the split can vary depending on the application/element at issue, ML model type, data dimensionality, etc. For example, at the validation stage, a relatively small dataset would suffice if the ML model has few or no hyperparameters-making validation straightforward.

Hardware processor 202 may further execute instruction 510 to train the desired ML model for each cluster using the training date It should be noted that AI/ML terminology may differ but may also be used interchangeably. For example, under some perspectives, training involves running an ML “algorithm” on training data. That is, the ML algorithm (comprising procedures implemented in code that are run on data) are trained, and an ML model (comprising model data and prediction algorithm) is then output by the ML algorithm. In other words, an ML algorithm can be considered a type of automatic programming, and an ML model represents the program. Regardless, in accordance with examples of the disclosed technology, once an ML model or algorithm is chosen for use with a particular cluster, that ML model/algorithm is fit on the training dataset.

Hardware processor 202 may further execute instruction 512 to validate the ML model for each cluster using the validation dataset. Subsequent to training, the fitted ML model can be used to make predictions with respect to the validation dataset. In this phase, the ML model (applicable to a cluster) is run on the validation dataset to assess performance of the ML model. In this phase, it may also be possible to fine-tune parameters or hyperparameters of the ML model. That is, the results of validation testing can provide metrics that can be used to train the ML model better. In some examples, execution of instructions 510 (to train) and instructions 512 (to validate) may be an iterative process, where the ML model learns/is trained, and running the ML model on the validation dataset is informative regarding the ML model's ability to learn/adapt.

Hardware processor 202 may further execute instruction 514 to test accuracy of the ML model for each cluster using the testing dataset. Splitting of the raw data into training, validation, and testing datasets allows for the testing dataset (and the validation dataset) to present “new” data that the ML model has not yet seen (on which the ML model has not yet been run). This testing phase allows for the trained and validated ML model to be assessed regarding its performance when encountering new data in an operational environment. In contrast to the validation phase, the result of executing instruction 514 to test the accuracy of the ML model for each cluster is a notification or some confirmation that the ML model is working as desired, e.g., is making predictions with desired accuracy.

Hardware processor may execute instruction 516 to, in response to exhibiting desired accuracy, operationalizing the ML model for each cluster. In this phase, the ML model for a particular cluster can be deployed on the system/network, meaning the ML model has been activated and is ready to receive raw data from, e.g., eNodeBs and gNodeBs, and predict the health of such elements.

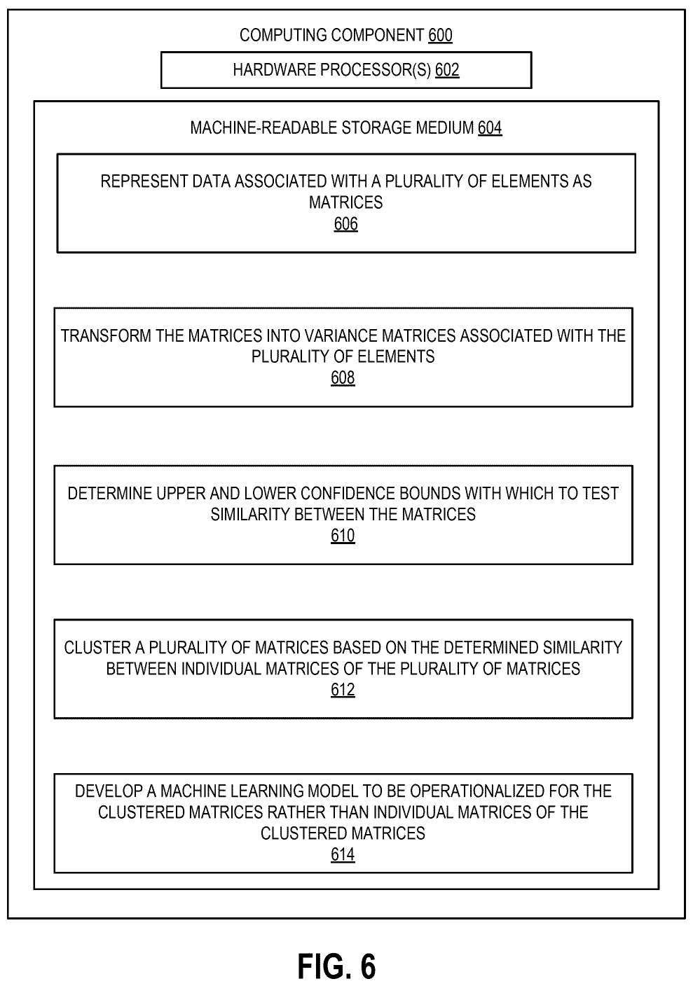

FIG. 6 is an example computing component 600 that may be used to implement various features of the elements, network functions, etc. described herein, more particularly, a directed acyclic graph (DAG) of calculations. Computing component 600 may be, for example, a server computer(s), a controller(s), or any other similar computing component(s) capable of processing data. In the example implementation of FIG. 6, the computing component 600 includes a hardware processor 602, and machine-readable storage medium 604 may embody, e.g., a DSP datacenter or an application, such as a health monitoring application running in a DSP datacenter, in the context of DSPs.

Hardware processor 602, may be similar/operate similarly to hardware processor 202 (FIG. 2) may be one or more central processing units (CPUs), semiconductor-based microprocessors, and/or other hardware devices suitable for retrieval and execution of instructions stored in machine-readable storage medium 604. Hardware processor 602 may fetch, decode, and execute instructions, such as instructions 606-614, to optimize/simplify ML model use in a system.

A machine-readable storage medium, such as machine-readable storage medium 604 may be similar to/operate similarly to machine-readable storage medium 604. As described in detail below, machine-readable storage medium 604 may be encoded with executable instructions, for example, instructions 606-614.

Hardware processor 602 may execute instruction 606 to represent data associated with a plurality of elements as matrices. As described here, when data to be analyzed is either multi-dimensional, multi-variate, or weakly correlated (or is any combination thereof), the data is representable as random matrices. That is, a random matrix refers to a matrix where at least some matrix elements equate to random variables. Random matrices are used to represent properties of physical systems, like the aforementioned nodes of a network, mathematically, as matrix problems. However, the typical application of AI/ML to individual nodes or elements is problematic when the scale of a system is such that there are too many nodes/elements. The vast amounts of data associated with such systems, and the building of a commensurately large number of ML models is untenable. Accordingly, examples of the disclosed technology leverage certain mechanisms to reduce the number of ML models needed for a system (by clustering or grouping together nodes/elements that behave similarly, and for which a common ML model can be applied).

To effectuate this reduction in ML models, hardware processor 602 may execute instruction 608 to transform the matrices into variance matrices associated with the plurality of elements. As described herein, examples of the disclosed technology derive diagonal matrices from the random matrices, where the diagonal matrices contain variance information associated with the plurality of elements. As described herein, clustering the random matrices will not suffice given the nature of the data at issue. Rather, examples of the disclosed technology leverage AI/ML to perform the desired clustering of the random matrices, but only after first, reducing the random matrices to singular vector/diagonal matrices. By deriving diagonal matrices that correspond to random matrices, the ability to use AI/ML for clustering becomes possible. Such diagonal matrices mathematically represent the random matrices, but as diagonal matrices containing the variances or eigenvalues of the principal components of the data reflected in the random matrices. That is, whereas the random matrices reflect physical components in the vector space, the diagonal matrices represent principal components in the vector space.

Once the raw data/random matrices has/have been transformed into an AI/ML-friendly format, hardware processor 602 may execute instruction 610 to determine upper and lower confidence bounds with which to test the similarity between the matrices (which ultimately reflects the similarity of data generated by the elements). As described above, Chi-square testing techniques may be used to determine confidence bounds. Using ratio of traces determinations achieved using F-distribution techniques, the similarities (or dissimilarities) between objects or nodes may be determined, i.e., whether or not the ratio of traces is in the neighborhood of unity, where the neighborhood of unity can be defined by the lower and upper confidence bounds.

Hardware processor 602 may execute instruction 612 to cluster a plurality of the matrices based on the determined similarity between the matrices. In accordance with some examples, an n-dimensional vector is generated using the variance values of the diagonal matrices derived from the random matrices. The n-dimensional vectors allows for the application of a clustering algorithm, such as a hierarchical clustering algorithm, e.g., agglomerative clustering. Agglomerative clustering, which treats nodes or elements as clusters themselves, and works to group those clusters, tends to result in the clustering of random matrices, faster and with better precision than other approaches. In other words, with agglomerative clustering, the resulting/determined clusters of nodes or elements is achieved “organically,” i.e., without pre-defining, ahead of time, the number of desired clusters. Ultimately, with any clustering method or technique, the number of ML models generated will be reduced, but determining the number of clusters before understanding the similarities/dissimilarities between nodes or elements would result in lesser ML model accuracy. That said, the disclosed technology is not limited to agglomerative clustering. For example, divisive clustering (a “top-down” approach versus the “bottom-up” approach of agglomerative clustering) may be used instead, where data points are combined into a single cluster, which can be divided as the distance between the data points increases. Here too, the result is an organically-determined set of clusters, rather than a pre-determined or un-informed set of clusters.

Hardware processor 602 may execute instruction 614 to develop an ML model to be operationalized for the clustered matrices rather than individual matrices of the clustered matrices. The above-described clustering reduces the number of ML models that need to be developed/applied because ML models can be developed/applied to multiple elements, e.g., nodes, that belong to a cluster. The derivation of matrices/vectors as described herein avoids losing the character of the raw data (dimensionality, multi-variate, weakly correlated). Thus, despite, in many cases, much smaller numbers of ML models being operationalized, accuracy can still be maintained. For example, in a network whose RAN includes more than 800 eNodeBs, using examples of the disclosed technology can result in the creation of node clusters numbering approximately 60 to 200 nodes (i.e., cluster sizes of 60 to 200 objects). This can result in significant reductions in the number of ML models needed to support a system. That is, with such cluster sizes, assuming three clusters of 200-plus eNodeBs, and one cluster of 60-plus eNodeBs, only four ML models would be generated, which is orders less than 800, as would be the case with conventional applications of AI/ML, where an ML model is generated for each object, in this case, each eNodeB.

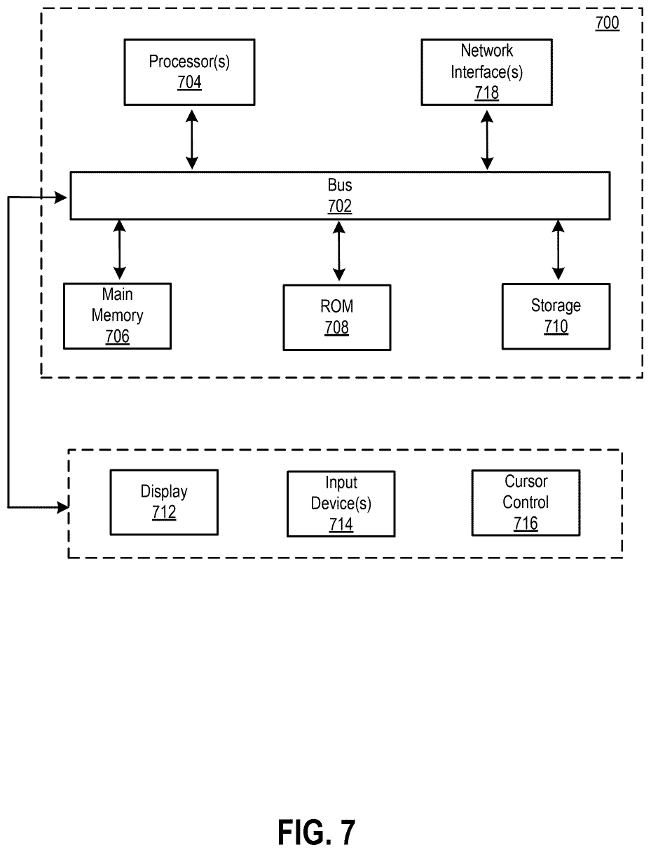

FIG. 7 depicts a block diagram of an example computer system 700 in which various of the examples described herein may be implemented. For example, the functionality of one or more of the elements, NFs, etc. illustrated in any of FIGS. 1-6 may be implemented or effectuated by computer system 700. The computer system 700 includes a bus 702 or other communication mechanism for communicating information, one or more hardware processors 704 coupled with bus 702 for processing information. Hardware processor(s) 704 may be, for example, one or more general purpose microprocessors.

The computer system 700 also includes a main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

The computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions. Computer system 700 may further still, include a network interface(s) 718 coupled to bus 702 that provides data communication to one or more network link. Network interface(s) 718 may be an integrated services digital network (ISDN) card, cable modem, satellite modem, or a modem to provide a data communication connection to a corresponding type of telephone line, LAN card, WAN component, etc.

In general, the word “engine,” “component,” “system,” “database,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 700 may implement the techniques described herein using customized hard-wired logic, one or more ASICs or FPGAs, firmware and/or program logic which in combination with the computer system causes or programs computer system 700 to be a special-purpose machine. According to one example, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same. Non-transitory media is distinct from but may be used in conjunction with transmission media.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps. Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system, comprising:
at least one processor; and
a machine-readable storage medium including instructions that when executed, cause the at least one processor to:
represent data associated with a plurality of elements as matrices;
transform the matrices into variance matrices associated with the plurality of elements;
determine upper and lower confidence bounds with which to test similarity between the matrices;
cluster a plurality of matrices based on the determined similarity between individual matrices of the plurality of matrices; and
develop a machine learning model to be operationalized for the clustered matrices rather than individual matrices of the clustered matrices

2. The system of claim 1, wherein the data comprises data that is at least one of multi-dimensional, multi-variate, time-series data.

3. The system of claim 1, wherein the matrices are random matrices.

4. The system of claim 3, wherein dimensionalities of the variance matrices correspond to dimensionalities of the variance matrices' respective random matrices.

5. The system of claim 1, wherein the instructions that cause the at least one processor to transform the matrices further causes the at least one process to derive diagonal matrices from the matrices, the diagonal matrices comprising variance values representing principal components of the data in a vector space.

6. The system of claim 4, wherein the instructions that cause the at least one processor to derive the diagonal matrices further cause the at least one processor to apply a principal component analysis algorithm to the matrices.

7. The system of claim 1, wherein the instructions that cause the at least one processor to determine the upper and lower confidence bounds, comprises performing Chi-distribution testing to determine the upper and lower confidence bounds.

8. The system of claim 1, wherein the determined similarity is based on an F-distribution-determined ratio of traces, the ratio of traces comprising a comparison of two variance matrices.

9. The system of claim 1, wherein the instructions that cause the at least one processor to cluster the plurality of matrices further causes the at least one processor to perform agglomerative clustering on the plurality of matrices to determine one or more clusters of subsets of the plurality of matrices.

10. A method, comprising:
pre-processing raw data associated with a plurality of network elements;
performing pair-wise similarity determinations based on the pre-processed raw data to determine similarities between the plurality of network elements;
clustering the plurality of network elements, wherein a cluster comprises at least a subset of the plurality of network elements having similar characteristics in accordance with the pair-wise similarity determinations;
generating a machine learning model for each cluster; and
operationalizing the machine learning model for each cluster.

11. The method of claim 10, wherein the raw data comprises high-dimension, multi-variate, time-series data generated by the network elements.

12. The method of claim 10, wherein the pre-processing of the raw data comprises representing the raw data as random matrices corresponding to each of the plurality of network elements.

13. The method of claim 12, wherein the pre-processing of the raw data comprises transforming the random matrices to diagonal matrices comprising eigenvalues representative of a total amount of variance explained by a given principal component of a network element.

14. The method of claim 13, wherein performing the pair-wise similarity determination comprises determining confidence intervals relative to the eigenvalues of the diagonal matrices.

15. The method of claim 14, further comprising extending the determined confidence intervals back to the raw data using Chi-square distribution.

16. The method of claim 15, further comprising calculating a ratio of traces representative of two diagonal matrices being compared.

17. The method of claim 16, wherein the diagonal matrices are representative of a pair of network elements or a single network element at different time intervals.

18. The method of claim 16, wherein a trace of the ratio of traces is determined by creating an n-dimensional vector comprising eigenvalues from a diagonal matrix, and summing the eigenvalues.

19. The method of claim 16, wherein the clustering of the plurality of network elements comprises clustering those network elements whose ratio of traces evidence similarity with one another.

20. The method of claim 17, wherein the generating of a machine learning model comprises dividing the raw data associated with each of the plurality of network elements into training, validation, and testing datasets
